(19) United States
(12) Patent Application Publication
(10) Pub. No.: US 2011/0312276 A1
(43) Pub. Date: Dec. 22, 2011

(54) Method for calibrating a terminal with a multi-sector antenna, and mesh network terminal

(75) Inventors: Jean-Luc Robert, Betton (FR); Ali Louzir, Rennes (FR); Philippe Minard, Sur Ille (FR); Philippe Chambelin, Chateaugiron (FR)

(73) Assignee: Thomson Licensing

(21) Appl. No.: 13/138,516

(22) PCT Filed: Feb. 24, 2010
(86) PCT No.: PCT/FR2010/050308

§ 371 Date: Aug. 30, 2011

(30) Foreign Application Priority Data
Mar. 3, 2009 (FR) 0951340

(51) Int. Cl. H04B 1/00

(52) U.S. Cl. 455/63.1

(57) ABSTRACT

The invention relates to a method for calibrating a terminal with a multi-sector antenna in a mesh broadcasting network that comprises at least one other terminal. The method includes: the selection of one sector of the terminal antenna to be calibrated, the reception by the selected sector, of identification signals transmitted by each of the other terminals present in the network, as well as the information on the received signal level; and the storage, for each sector, of different identification signals of the terminals present in the network, and of the information on received signal level, into the memory of the terminal to be calibrated.

The present invention relates to a method for calibrating a terminal comprising a multi-sector antenna in a mesh network. It also relates to a mesh network terminal comprising such a multi-sector antenna and the mesh network connecting the different terminals together.

Terminals comprising multi-antennas or multi-sector antennas are used particularly in MIMO (Multiple Input Multiple Output) type devices to standards 802.11 or 802.16 and more particularly in the context of mesh networks in which the use of sector antennas authorises the routing of data to the different nodes of the network via the beamforming technique.

The efficiency of a system of terminals is clearly increased by maximising the capacity of the transmission channel due to the use of directive antennas. In fact they enable the interferences, which are at the origin of the sudden drop in the capacity of networks as soon as they attain a certain density or level of traffic, to be significantly reduced.

Networks known as “ad hoc mobile” networks are defined by the connections between the nodes of a group of mobile nodes across a wireless medium. These nodes can freely and dynamically organise themselves and thus create an arbitrary and temporary topology of networks known as ad-hoc mobile networks, thus enabling the terminals to interconnect.

Mesh networks are constructed on a combination of fixed and mobile nodes interconnected by wireless links.

In the standard 802.11 an Internet access is considered. In this type of network, only some nodes (mesh nodes) have a direct connection to Internet, the rest of the nodes serving as relay points. In fact, instead of requiring an Internet access for each network point in the areas not necessarily possessing communication infrastructure, the multi-hopping technique is used and some nodes thus play the role of a router.

Such a concept is based on the use of 2 distinct radio systems on the same network node, one serving for the client application for example on the 802.11g standard at 2.4 GHz while the other radio operates on the 802.11a standard in the 5 GHz band and participates in the multi-hopping routing of the backbone mesh network.

On one hand the mesh networks have co-channel links in a cellular environment of reduced size, on the other hand the MAC (Media Access Control) structure of 802.11 of CSMA/CA (Carrier Sense Multiple Access with Collision Avoidance) type causes each link between channels to operated in shared time in order to avoid packet collisions, the result is very poor spatial reuse and thus a lower transmission capacity of the network.

In addition the use of omnidirectional antennas enabling a wireless link between the nodes is a source of interferences between the adjacent nodes.

Moreover concepts such as multiple antenna techniques known as MIMO (Multiple Input multiple Output) or beamforming antennas are used.

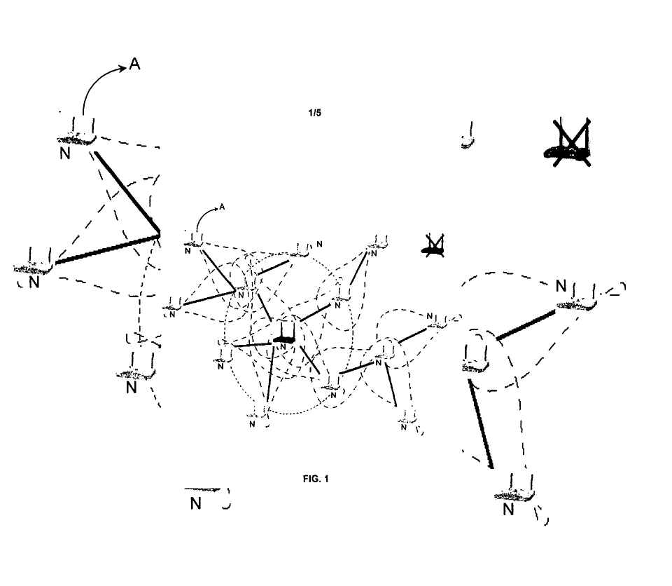

A mesh network architecture is described in the patent US2007/0153817 and is shown in FIG. 1. This patent claims on one hand the use of directional dual-band antennas at each node N that thus enable the interferences on the adjacent nodes to be reduced. The sectors represented in dotted lines, are positioned according to routing requests. A “multi-hopping” method operating simultaneously on the respective frequencies 2.4 GHz and 5 Ghz is described. Thus with this device, at each routing, it is necessary to recalculate the different links between the nodes and to determine the sector of the antenna most adapted to sector scanning. The invention aims to overcome these disadvantages.

The invention relates to a method for calibrating a terminal with a dual-band multi-sector antenna in a mesh broadcasting network that comprises at least one other terminal. It is characterized by steps for selecting at least one sector of the terminal antenna to be calibrated, for receving by the selected sector of identification signals transmitted by each of the other terminals present in the network as well as information of the received signal level and for storing in the memory of the terminal to be calibrated, for each selected sector, different identification signals of terminals present in the network as well as the information on the received signal level.

In another embodiment, the selection of each antenna sector of the terminal to be calibrated is made by command from a switching means associated with each sector.

Preferentially this method applies to all the terminals of the mesh network.

Preferentially the calibration is repeated at regular intervals.

The invention also consists in a terminal of a mesh network comprising at least one other terminal, and including a multi-sector antenna.

The terminal also comprises a memory to memorise for each antenna sector the identification signals received that are transmitted by each of the other terminals present in the mesh network as well as the information of the level to the signal received thus enabling a calibration of the terminal with respect to the other terminals of the network.

Preferentially the multi-sector antenna is dual-band.

Preferentially switching means are associated with each antenna sector thus enabling the successive selection of each antenna sector.

Preferentially low-pass or notch filters are associated with each antenna sector.

The invitation also consists in a mesh network formed by a plurality of terminals.

The invention has the advantage of enabling an optimal selection of an antenna sector of a terminal during the connections between the terminals of a mesh network.

The characteristics and advantages of the aforementioned invention as well as others will emerge more clearly upon reading the following description made with reference to the drawings attached, wherein:

FIG. 1 already described, shows a topology of a mesh network based on sector antennas,

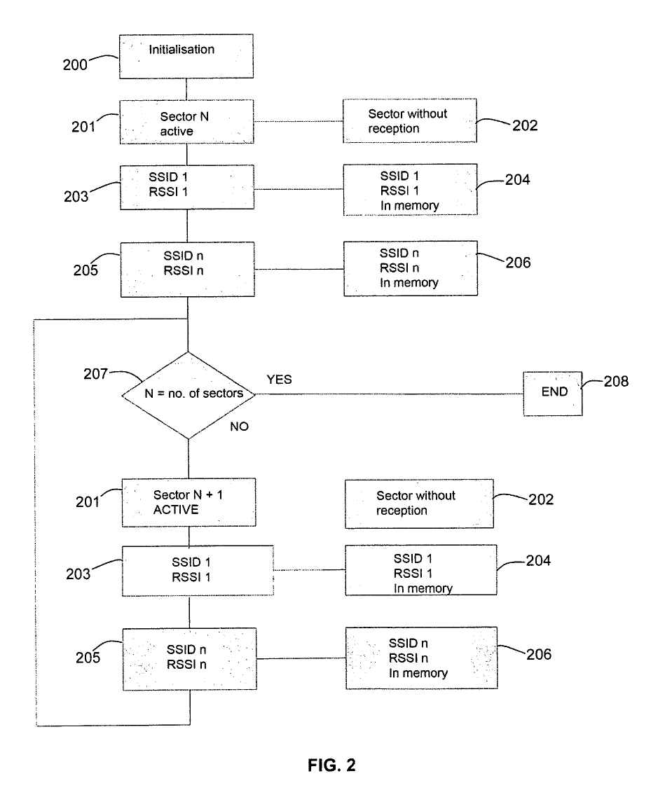

FIG. 2 shows a phase of a method for calibration of the mesh network according to the invention,

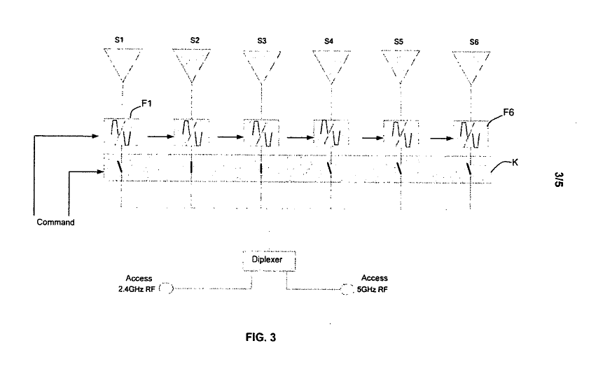

FIG. 3 shows a topology of a multi-sector dual-band antenna,

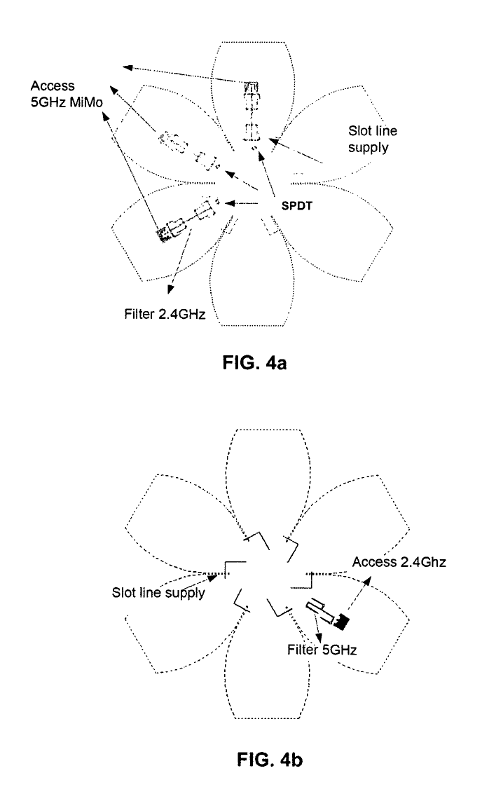

FIGS. 4a and 4b show an embodiment of sides of a Vivaldi profile six sector antenna,

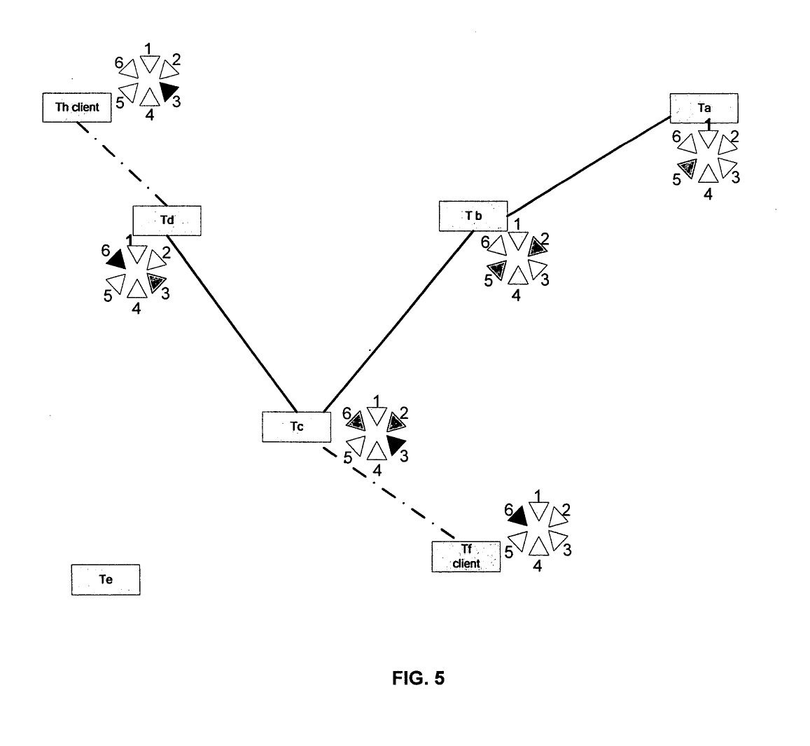

FIG. 5 shows a transmission configuration in a mesh network according to the invention.

The principle of the invention consists in operating a calibration phase of a network that enables simultaneously at each terminal (Access Point) located on a network node to analyse its reception configuration in terms of identification of terminals present in its environment and in terms of level received of identified terminals, this phase being implemented by a sequential scanning over 360° of antenna sectors of this terminal, the information resulting from this scanning is stored in the memory of each of the terminals.

This method summarized in the diagram of FIG. 2 is based on the reception by a terminal to be calibrated of SSID (Service Set Identifier) identifiers, information included in the network identification packet headers, transmitted by another terminal of the network considered.

For each of the terminals of the network considered, these identifiers as well as the associated signal level information RSSI (Received Signal Strength Indication) are thus stored in the memory of each terminal.

Each terminal associated with each node possesses thus a type of cartography of its environment in the memory. This pseudo geo-localisation enables each terminal to store in its memory the neighbouring identifiers and their level of received power during a sector scanning by the antenna.

The precision of this geo-localisation linked to the criterion of maximum received power depend of the granularity of the scanning and thus to the directivity of the considered antenna that is a function of the number of sectors of the considered antenna.

It also depends on the environment, nevertheless in a static exterior environment, the maximum received power remains strongly correlated to a main transmission path. Using the recorded cartography, a main transmission path is thus determined.

With a high terminals density, the beam having the maximum received power is not necessarily that directed towards the transmitter terminal as interferences may interfere with signals reception.

It is important to regularly repeat the calibration to adapt to any changes in the environment. According to the invention the method is repeated at regular intervals being able to be spaced out when information on the stability of the mesh network is received. Conversely, any environment change recorded or signalled leads automatically to a re-calibration of the mesh network.

The diagram of FIG. 2 shows an example of calibration of a terminal located on a node of a mesh network. This calibration begins then with a first step 200 of initialisation of the first terminal to be calibrated T0 of the network. The nature of the antenna of this terminal as well as the number of sectors, for example 6 sectors, is thus recorded.

The next step 201 consists in activating one of the sectors for example the sector numbered 1 and in analysing it reception capacity in terms of identification of terminals present in its environment in the mesh network and in terms of the level received of identified terminals. During the step 202, if no reception is possible, this non-reception information is memorised in association with the activated sector of the antenna considered.

Conversely, the information considered is for example based on the reception of SSID (Service Set Identifier) identifiers included in the header of the network identification packets, transmitted by each terminal of the network considered.

During steps 202 to 206, at the terminal to be calibrated and at a sector of the selected antenna are thus stored in the memory the identification information of each of the n other terminals considered SSID1 to SSIDn, with the RSSI (Received Signal Strength Indication) signal level information, RSSI1 to RSSIn corresponding to the different network terminals. This phase is followed by step 207 corresponding to a switch on the sector according to the antenna of the terminal to be calibrated in a way to have a sequential analysis over 360° of N sectors of the antenna of this terminal. The information resulting from this scanning are then stored in the memory of each of the terminals via the steps corresponding to the steps 202-206. When this information has been recorded for all of the N sectors of the antenna, then the calibration is terminated, which corresponds to the final step, step 208.

FIG. 3 shows a topology of a multi-sector dual-band antenna such as that used for example by the invention.

This dual-band antenna comprises 6 sectors S1-S6 for example. It can include a different number, either higher or lower, depending on the density and size of the network.

In fact the more the network is dense, the more interesting it is to have a significant sectoring of antenna.

This antenna will preferentially be printed planar of tapered slot type (Vivaldi) or dipole or Yagi for example, each of the antenna sectors may cover the 2 frequency domains targeted by the application, the band 2.4 GHz for the client service or the band 5 GHz for the multi-hopping routing service. A diplexer enables the bilateral isolation of RF signals to be assured.

Each antenna sector is connected to the diplexer via the intermediary of a low-pass or adaptable notch filter F1-F6 associated with a switch K. This switch K authorizes with command signals the transmission or reception (Tx/Rx) of the signals. The signal is received by an antenna sector or transmitted by one or several antenna sectors simultaneously. This switch K is for example assured via a PIN diode or an AsGa switch.

The filter reduces the interferences between the different channels.

The signals in the band 2.4 GHz and 5 GHz are thus received or transmitted on one of the sectors on the RF access 2.4 GHz and 5 GHz via the intermediary of a diplexer. The control signals of filters, as these of the switches, are from the MAC (Medium Access Control) control unit.

FIG. 4 shows an embodiment of a sectored Vivaldi antenna corresponding to the preceding topology.

This dual-band antenna architecture groups in a single antenna broadband RF access in the 5 GHz band, a dynamic sectoring function controlled by the MAC (Medium Access Control) command unit enabling benefiting from gains in performance linked to directivity, RF access in the 2.4 GHz band, a frequency selective supply device on each of the RF accesses thus ensures the isolation required for the simultaneous functioning of 2.4 and 5 GHz radio blocks.

The 5 GHz accesses are grouped on one of the two sides (FIG. 4a) of the multi-sector antenna while the 2.4 GHz accesses are grouped on the other side (FIG. 4b). The 2.4 HHz band filters are associated with the 5 GHz access while the 5 GHz band filters are associated with the 2.4 GHz accesses. These filters are preferably produced in hyper-frequency technology which enables them due to a reduced size to be able to be inserted into each RF access.

The invention makes it possible to select simultaneously several antenna sectors at the 2 operating frequencies. Thus a transmission in several different directions is possible.

FIG. 5 shows a transmission configuration according to the invention on a network section.

To a request for Internet access corresponding to the terminal Ta, by terminals Tf and Th corresponding to the clients f and h, a first routing managed by the MAC command unit is organised via the terminals Tb, Tc and Td.

Each of these terminals Ta, Tb, Tc, Td, Te, Th and Tf operates then a pre-positioning of multi-sector antennas in accordance with the routing requested according to the calibration information of each terminal.

Thus in the calibration information of the terminal Th, it is memorised that the communication with the terminal Td is optimised via the intermediary of the sector S3 of the multi-sector antenna at the required frequency of 2.4 GHz.

The calibration information of the terminal Tc enable management of routing links at 5 GHz with the terminal Tb via the sector 2 of the antenna and with the terminal Td via the sector 6 and management of the client link at 2.4 GHz with the terminal Tf via sector 3. The antenna of the terminal Tc thus manages jointly the routing links with the other terminals at 5 GHz and the client link with the terminal Tf at 2.4 GHz.

It appears nevertheless that the efficiency of such a concept in terms of interferences depends on one hand on the directivity of antennas, on the geographic density of the network but also on the isolation capacity of adjacent sectors. In fact the routing links operate in different channels of the same frequency band, it appears that despite the antenna selection, energy between channels can disturb the transmission. For this purpose and also in order to improve the selectivity of transmission and thus limit the interferences inherent in lack of directivity and in the imperfect isolation of switches at 5 GHz, a low-pass or adjustable notch filter device has been inserted in each of the antenna sectors. Thus assigning a filter-stop band at 5 GHz to the sectors adjacent to those implicated in the routing, improves in a dense cellular environment the isolation of these sectors and implements an additional angular selectivity.

1. Method for calibration of a terminal with a multi-sector antenna in a mesh broadcast network comprising at least one other terminal, wherein the method comprises steps for:
selecting at least one of the sectors of the antenna of the terminal to be calibrated,
receiving by the selected sector the identification signals transmitted by other terminals present of the mesh broadcast network as well as the received signal level information, and
storing in the memory of the terminal to be calibrated, for each selected sector, the different received identification signals of network terminals and the corresponding items of received signal level information.

2. Method for calibration according to claim 1 wherein the selection of the antenna sector of the terminal to be calibrated is made by command of a switching means associated with each sector.

3. Method for calibration according to claim 1 wherein this method applies to at least one operating frequencies of each antenna sectors.

4. Method for calibration according to claim 1 wherein the calibration is repeated at regular intervals.

5. Terminal of a mesh network comprising at least one of the other terminals, and comprising a multi-sector antenna, characterized in that the terminal also comprises a memory to memorise for at least one of the antenna sectors the identification signals received that are transmitted by each of the other terminals present in the mesh network as well as the information corresponding to the received identification signal level thus enabling a calibration of the terminal with respect to the other terminals of the network.

6. Terminal of a mesh network according to claim 5 wherein witching means are associated with each antenna sector thus enabling the successive or consecutive selection of each antenna sector.

7. Terminal of a mesh network according to claim 5 wherein the multi-sector antenna is dual-band.

8. Terminal of a mesh network according to claim 7 wherein low-pass or notch filters are associated with each antenna sector.

9. Mesh network formed by a plurality of terminals as defined in claim.
